(19) United States
(12) Patent Application Publication
(10) Pub. No.: US 2002/0061075 A1
(43) Pub. Date: May 23, 2002

(54) Method of optimizing the performance of a mobile radio system transmitter

(75) Inventor: Luc Dartois, Carrieres Sous Poissy (FR)

Correspondence Address: SUGHRUE, MION, ZINN,, MACPEAK & SEAS, PLLC, Suite 800, 2100 Pennsylvania Avenue, N.W., Washington, DC, 20037-3213, US

(73) Assignee: ALCATEL

(21) Appl. No.: 09/987,758

(22) Filed: Nov. 15, 2001

(30) Foreign Application Priority Data
Nov. 17, 2000 (FR) 00 14 906

(51) Int. Cl. H04L 27/06; H04L 27/14

(52) U.S. Cl. 375/316

(57) ABSTRACT

A method of optimizing the performance of a mobile radio system transmitter using processing operations including discrete Fourier transform (DFT) computation, filtering in the frequency domain, inverse discrete Fourier transform (IDFT) computation, overlapping of processed sample blocks, and oversampling, wherein, for a given input sampling frequency, a given order of magnitude of the output sampling frequency, and a given order of magnitude of the required frequency resolution, the length of the DFT and the length of the IDFT are chosen in such a manner as to enable the finest possible choice of the percentage overlap and/or the oversampling factor.

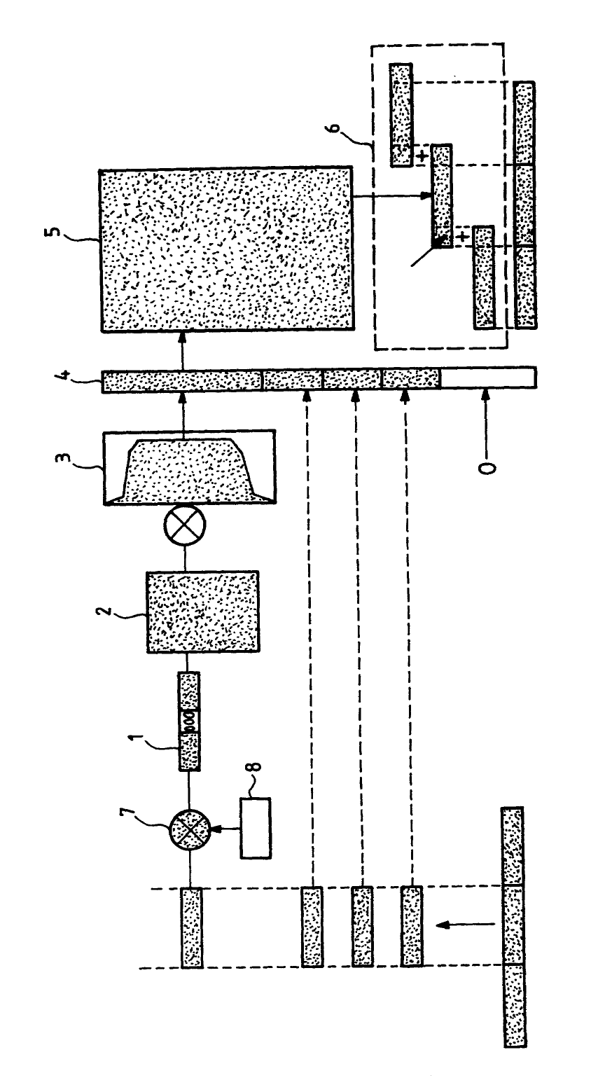

### BACKGROUND OF THE INVENTION

In such transmitters, a distinction is usually made between processing functions in base band, at intermediate frequencies, and at radio frequencies. It is advantageous to implement base band processing functions and intermediate frequency processing functions in the digital domain. These functions essentially include filter functions and are advantageously effected in the frequency domain, in particular in the case of multicarrier transmitters (used in base stations in particular).

Transformation from the time domain to the frequency domain is then effected for each carrier by means of a discrete Fourier transform (DFT). Filtering for each carrier is then effected by means of simple operations of multiplication by filter coefficients. Converse transformation from the frequency domain to the time domain is then effected for all of the carriers by means of an inverse discrete Fourier transform (IDFT).

There is also generally some provision for the blocks of samples processed in this way to overlap in accordance with the overlap technique, which has two variants, referred to as “overlap-add” and “overlap-save”.

There is also generally provision for the output sampling frequency to be different from the input sampling frequency. In particular, if it is higher, the term “over-sampling” or “interpolation” is used.

Examples of such architectures can be found in the literature, for example in document WO 99/65172.

Performance (in terms of computation power, cost, group delay, synthesized signal quality, etc.) depends on the choices made for the parameters defining the processing operations: the input and output sampling frequencies, the lengths of the DFT and the IDFT (both expressed as a number of samples), the percentage overlap, etc. It would therefore be desirable to have a method of choosing the above parameters in such a manner as to optimize performance for a given system. One particular object of the present invention is to respond to that requirement.

### OBJECTS AND SUMMARY OF THE INVENTION

Thus the present invention provides a method of optimizing the performance of a mobile radio system transmitter using processing operations including discrete Fourier transform (DFT) computation, filtering in the frequency domain, inverse discrete Fourier transform (IDFT) computation, overlapping of processed sample blocks, and oversampling, wherein, for a given input sampling frequency, a given order of magnitude of the output sampling frequency, and a given order of magnitude of the required frequency resolution, the length LDFT of the DFT and the length LIDFT of the IDFT are chosen in such a manner as to enable the finest possible choice of the percentage overlap and/or the oversampling factor.

Thus, in particular, the present invention optimizes the computation power, and therefore the cost, the group delay (the time delay between the output signal and the input signal) due to the filter function, and the quality of the synthesized signals.

In a first embodiment, if the ratio LIDFT/LDFT is not an integer, the denominator of the fraction LIDFT/LDFT when simplified is chosen to be as small as possible, to provide the finest possible choice of the length L of the blocks of samples with no overlap at the input of the DFT, and therefore the finest possible choice of the percentage overlap.

In the first embodiment, the input sampling frequency being equal to 3.84 MHz, the required value for the output sampling frequency being close to 80 MHz, and the required value of the frequency resolution being close to 80 kHz, it is advantageous if LDFT is chosen to be equal to 48 and LIDFT is chosen to be equal to 1024.

In a second embodiment, if the ratio LDFT/LIDFT is an integer, the lengths LDFT and LIDFT are chosen in such a manner as to provide the finest possible choice of the oversampling factor or the output sampling frequency.

In the second embodiment, the input sampling frequency being equal to 3.84 MHz, the required value of the output sampling frequency being close to 80 MHz, and the required value of the frequency resolution being close to 80 kHz, it is advantageous if LDFT is chosen to be equal to 45 (5*9) and LIDFT is chosen to be equal to 1260 (5*9*7*4) enabling fast Rader-Vinograd implementation of the DFT and the IDFT.

Furthermore, the present invention also solves the problem that the required center frequency for each carrier does not necessarily correspond to the closest frequency sample from the DFT, especially once the values of the above parameters have been chosen. In other words, the channeling of the carriers obtained in this way does not necessarily coincide with that required for the system concerned.

Another object of the present invention is to solve this problem.

The invention also provides a method of optimizing the performance of a mobile radio system transmitter using processing operations including discrete Fourier transform (DFT) computation, filtering in the frequency domain, and inverse discrete Fourier transform (IDFT) computation, wherein, before effecting said DFT computation, a frequency shift DF is applied in the time domain equal to the algebraic difference between the required central frequency of the corresponding filtered signal and the closest frequency sample coming from said DFT computation.

Furthermore, the present invention also solves the problem of phase jumps appearing at the output between the last sample of one IDFT and the first sample of the next IDFT, which phase jumps are due to the use of a length L that is not a sub-multiple of LIDFT.

The invention further provides a method of optimizing the performance of a mobile radio system transmitter using processing operations including discrete Fourier transform (DFT) computation, filtering in the frequency domain, and inverse discrete Fourier transform (IDFT) computation, wherein, before effecting said DFT computation, to compensate phase jumps between samples at the output of the IDFT, a complex multiplication is effected of the input samples by a complex of unit modulus and opposite phase to the phase jump to be compensated.

According to another feature, the phase jump to be compensated being periodic and predictable by the function L/LDFT, said complex is expressed in the form:

decp=exp(2*j*pi*numc/LDFT*L*(NUMT−1)),

where:

NUMT is the relative chronological number of the slices or blocks of L samples, and

numc is the IDFT channel number corresponding to the central frequency of the carrier concerned or to the ratio Fc/Fs modulo LIDFT (Fc is the required carrier frequency).

Furthermore, the present invention also solves the following additional problem.

Consider the situation in which the overlap technique used is the overlap-add technique, i.e. one in which LDFT-L zeros are added to blocks of L consecutive non-overlapping samples of the incident signal to form blocks of LDFT samples to which a DFT of length LDFT is applied.

In the prior art, and as also described in the documents previously cited, the LDFT-L zeros are placed at the ends of the blocks of LDFT samples.

Because the DFT operates on blocks of samples of limited duration, and because the spectrum obtained from the DFT is also limited, overlap phenomena occur in the time domain and degrade the quality of the synthesized signal. Also, filling in with zeros has an effect on the group propagation time (the time delay between the output signal and the input signal), which in some cellular systems must be minimized because it influences performance in terms of power control and cell radius (as in the case of code division multiple access (CDMA) third generation systems such as the Universal Mobile Telecommunication System (UMTS), for example).

A further object of the present invention is to limit such degradation.

The invention therefore further provides a method of optimizing the performance of a mobile radio system transmitter using processing operations including discrete Fourier transform (DFT) computation, filtering in the frequency domain, inverse discrete Fourier transform (IDFT) computation, and overlapping of processed sample series or blocks, said overlapping being obtained by adding LDFT-L zeros to blocks of L incident signal samples to obtain blocks of LDFT samples to be applied to a DFT of length LDFT, and wherein the LDFT samples of said blocks are rotated in such manner that the LDFT-L zeros are placed as close as possible to the center of the blocks and the L signal samples are placed on either side of the LDFT-L zeros.

According to another feature said blocks are rotated in such a manner that the LDFT-L zeros are placed as close as possible to the center of the blocks, to within one sample if L is odd.

The invention further provides a mobile radio system transmitter including means for optimizing performance by any of said methods.

### BRIEF DESCRIPTION OF THE DRAWING

Other objects and features of the present invention will become apparent on reading the following description of embodiments of the invention, which description is given with reference to the accompanying drawing, which is intended to show one example of processor means provided in a mobile radio system transmitter to which the present invention can be applied.

### MORE DETAILED DESCRIPTION

By way of example, the transmitter considered is a multicarrier transmitter (a four-carrier transmitter in the example shown) and the processing means include, as shown in the figure:

for each carrier:

means 1 for allowing a particular percentage overlap of the blocks of samples to be applied to the DFT,

means 2 for computing the discrete Fourier transform (DFT), and

frequency domain filter means 3, and for all the carriers:

means 4 for obtaining blocks of samples to be applied to the IDFT from blocks of samples obtained at the output of the filter means for the various carriers and for filling in with zeros to obtain blocks of length LIDFT,

inverse discrete Fourier transform (IDFT) computation means 5, and

means 6 for combining blocks of samples at the output of the IDFT with the same percentage overlap as in the means 1.

The DFT and the IDFT are usually implemented by means of fast computation algorithms such as the Cooley-Tuckey, Rader-Vinograd, etc. fast Fourier transform (FFT) algorithms. The type of algorithm used generally defines a DFT length LDFT and an IDFT length LIDFT. For example, LDFT must be an exact power of 2, 4 or 8 for Cooley-Tuckey algorithms or a product of mutually prime factors chosen from the list (2, 3, 4, 5, 6, 7, 8, 9, 16) for Rader-Vinograd algorithms.

Filtering is effected by means of simple operations of multiplying frequency samples obtained from the DFT by filter coefficients representing the Fourier transform of the impulse response of the filter. The filter template is shown diagrammatically in the figure, and is generally intended to isolate a given band of frequencies.

Descriptions of overlap techniques can be found in the literature, for example in the document previously cited or in “Multirate Digital Signal Processing”, Ronald E. Crochiere and R. Rabiner, Prentice-Hall, Inc., Englewood Cliffs, N.J. 07362.

The percentage overlap can be defined as the ratio LDFT-L/LDFT where L is the length of the blocks of samples without overlap before DFT and 1<L<LDFT.

For example, as shown in the figure, if the overlap is of the overlap-add type the means 1 for adding LDFT-L zeros to blocks of L samples of the incident signal and the means 5 enable overlapping by adding blocks of LIDFT samples from the IDFT.

The percentage overlap chosen is a function of the spectral imperfections and distortions of the synthesized signal that can be tolerated given the required filter template.

The oversampling factor (OVSF) is defined as the ratio Fs/Fe.

In the architecture considered, the parameters Fe, Fs, ΔF, LDFT and LIDFT are therefore linked by the following equations:

Fe=LDFT*ΔF,

Fs=LIDFT*ΔF, and

Fs=Fe*(LIDFT/LDFT).

As previously indicated, it would be desirable to have a method of choosing parameter values in such a way as to optimize performance. One particular object of the present invention is to satisfy this requirement.

Essentially, in accordance with the invention, for a given input sampling frequency, a given order of magnitude of the output sampling frequency, and a given order of magnitude of the required frequency resolution, the length of the DFT and the length of the IDFT are chosen in such a manner as to provide the finest possible choice of the percentage overlap and/or the oversampling factor.

For example, in an application to the Universal Mobile Telecommunication System (UMTS), the input sampling frequency Fe is equal to 3.84 MHz, the required value of the output sampling frequency Fs is of the order of 80 MHz, and the required value of the frequency resolution ΔF is of the order of 80 kHz, to obtain an accurate representation of the spectral template of the channel filter.

Accordingly, in a first embodiment, in the application to the UMTS considered by way of example, and with ΔF=80 kHz, if the IDFT is implemented by means of a Cooley-Tuckey algorithm, for example, and if the DFT is implemented by means of a Rader-Vinograd computation algorithm, for example, we can then choose:

LDFT=48, and

LIDFT=1024.

Thus:

LIDFT/LDFT=1024/48,

that is to say, on simplifying the fraction:

LIDFT/LDFT=64/3.

Also, the available values L must enable perfect phasing of output samples (namely a join in the case of overlap-save or an additive overlap in the case of overlap-add). For this, if LIDFT/LDFT is fractional, the only available values of L from the values from 1 to LDFT are those satisfying the following criterion:

(LIDFT/LDFT)*L integer.

If, as is the case in the example of application to the UMTS in particular, we wish to be able to obtain a wide choice of available overlaps, LIDFT/LDFT must then be a fraction which, when simplified, has a very small denominator, because it is the denominator that defines the overlap adjustment quantum.

For example, in the application to the UMTS considered by way of example, L can be chosen equal to 36, or any other multiple of 3 less than L=48, knowing that the necessary computation power is inversely proportional to L (the complete block processing cycle is executed every L*Fe seconds).

Accordingly, and more generally, in this first embodiment, if the ratio LIDFT/LDFT is not an integer, the denominator of the fraction LIDFT/LDFT when simplified is chosen to be as small as possible, to provide the finest possible choice of the length L of the sequences or blocks of samples, with no overlap, prior to DFT, and therefore the finest possible choice of the percentage overlap.

In a second embodiment, if the DFT and the IDFT are implemented by means of Rader-Vinograd algorithms, for example, in the application to the UMTS considered by way of example we may choose:

LDFT=45=5*9 (i.e. LDFT is around 48), and

LIDFT=(5*9)*(7*4) (i.e. LIDFT=LDFT*OVSF, with OVSF close to 28, so as not to be too far above 80 MHz, here 107.52 MHz).

Accordingly, in this second embodiment, if the ratio LDFT/LIDFT is an integer, it is beneficial to choose the lengths LDFT and LIDFT in such a manner as to have the finest possible choice of over-sampling factor and therefore an output sampling frequency as close as possible to the required value.

Furthermore, as previously indicated, another problem is that the closest frequency sample coming from the DFT does not necessarily correspond to the central frequency required for each carrier, especially when the values of the above parameters have been chosen. In other words, the channeling obtained in this way does not necessarily coincide with that required for the system concerned.

Another object of the present invention is to solve this problem.

Essentially, in accordance with the invention, before effecting said DFT computation, a frequency shift DF is applied in the time domain equal to the algebraic difference between the required central frequency for the corresponding filtered signal and the closest frequency sample obtained from said DFT computation.

This kind of frequency shift is applied by means labeled 7 in the figure. Accordingly, the wanted frequency can be synthesized, at the cost of a complex multiplication at the timing rate Fe for each carrier concerned. The means for generating DF, labeled 8 in the figure, can be limited to a short table if the harmonic relations between Fe, LDFT and DFmin (i.e. the minimum shift DF) are simple. In the example of application to the UMTS, in which said central frequencies can be adjusted with an increment of 200 kHz, and given the centering of the spectrum, it is necessary to provide for an adjustment in steps of 100 kHz, that is to say: DFmin=100 kHz−80 kHz=20 kHz. In this case, instead of being a numerically controlled oscillator (NCO), the means 8 can be limited to a small trigonometrical table of size Fe/20 kHz, that is to say 192 values, reducible to 192/8=24 real values (cosine(k*2*pi/24)), advantageously using the properties of trigonometrical symmetries.

The present invention also solves the problem of phase jumps at the output between the last sample of one IDFT and the first sample of the next IDFT, which phase jumps are due to using a length L that is not a submultiple of LIDFT.

Essentially, in accordance with the invention, before effecting said DFT computation, and to compensate the phase jumps between the samples at the output of the IDFT, a complex multiplication of the input samples by a complex of unitary modulus and opposite phase to the phase jump to be compensated is effected.

The phase jump to be compensated being periodic and predictable by the function L/LDFT, said complex is expressed in the following form:

decp=exp(2*j*pi*numc/LDFT*L*(NUMT−1)),

where:

NUMT is the chronological number relative of the slices or blocks of L samples, and

numc is the IDFT channel number corresponding to the central frequency of the carrier concerned, in other words, numc is the ratio Fc/Fs modulo LIDFT (Fc is the required carrier frequency).

Implementing this correction has no operative cost because these means can be integrated into the means 7 and 8. Moreover, in a tabulated implementation of “decp” the table remains small because fractions LDFT/L with a small denominator are always chosen (L<LDFT).

Furthermore, the present invention also solves the following additional problem.

Consider the case where the overlap technique used is the overlap-add technique, that is to say one in which LDFT-L zeros are added to blocks of L consecutive and non-overlapping samples of the incident signal to form blocks of LDFT samples to which a DFT of length LDFT is applied.

In the prior art, and as also described in the documents previously cited, the LDFT-L zeros are placed at the ends of the blocks of LDFT samples.

Because the DFT operates on blocks of samples of limited duration and the spectrum coming from the DFT is also limited, overlap phenomena in the time domain occur, degrading the quality of the synthesized signal.

Another object of the present invention is to limit such degradation.

Essentially, in accordance with the invention, in order to have symmetrical degradation for the samples at the right-hand and left-hand ends of the block of LDFT samples, and therefore to improve the quality of the synthesized signal, the LDFT samples of the block are subjected to a rotation so that the LDFT-L zeros are placed at the center of the block and the L signal samples are placed on either side of the LDFT-L zeros.

In the figure, this kind of sample rotation is shown as being provided by the means 1.

For example, in the application to the UMTS considered by way of example, in which LDFT is equal to 48 and L is equal to 36, a block applied to the input of the DFT includes, in this order:

samples 19 to 36 of a block of 36 signal samples,

12 samples consisting of zeros,

samples 1 to 18 of the block of 36 signal samples.

Thus this example further improves the group delay, which is reduced by 24 input samples, i.e. 512 output samples or 6.25 microseconds.

1. A method of optimizing the performance of a mobile radio system transmitter using processing operations including discrete Fourier transform (DFT) computation, filtering in the frequency domain, inverse discrete Fourier transform (IDFT) computation, overlapping of processed sample blocks, and oversampling, wherein, for a given input sampling frequency, a given order of magnitude of the output sampling frequency, and a given order of magnitude of the required frequency resolution, the length LDFT of the DFT and the length LIDFT of the IDFT are chosen in such a manner as to enable the finest possible choice of the percentage overlap and/or the oversampling factor.

2. A method according to claim 1, wherein, if the ratio LIDFT/LDFT is not an integer, the denominator of the fraction LIDFT/LDFT when simplified is chosen to be as small as possible, to provide the finest possible choice of the length L of the blocks of samples with no overlap at the input of the DFT, and therefore the finest possible choice of the percentage overlap.

3. A method according to claim 2, wherein, the input sampling frequency being equal to 3.84 MHz, the required value of the output sampling frequency being close to 80 MHz, and the required value of the frequency resolution being close to 80 kHz, LDFT is chosen to be equal to 48 and LIDFT is chosen to be equal to 1024.

4. A method according to claim 1, wherein, if the ratio LDFT/LIDFT is an integer, the lengths LDFT and LIDFT are chosen in such a manner as to provide the finest possible choice of the oversampling factor or the output sampling frequency.

5. A method according to claim 4, wherein, the input sampling frequency being equal to 3.84 MHz, the required value of the output sampling frequency being close to 80 MHz, and the required value of the frequency resolution being close to 80 kHz, LDFT is chosen to be equal to 45 and LIDFT is chosen to be equal to 1260.

6. A method of optimizing the performance of a mobile radio system transmitter using processing operations including discrete Fourier transform (DFT) computation, filtering in the frequency domain, and inverse discrete Fourier transform (IDFT) computation, wherein, before effecting said DFT computation, a frequency shift DF is applied in the time domain equal to the algebraic difference between the required central frequency of the corresponding filtered signal and the closest frequency sample coming from said DFT computation.

7. A method of optimizing the performance of a mobile radio system transmitter using processing operations including discrete Fourier transform (DFT) computation, filtering in the frequency domain, and inverse discrete Fourier transform (IDFT) computation, wherein, before effecting said DFT computation, to compensate phase jumps between samples at the output of the IDFT, a complex multiplication is effected of the input samples by a complex of unit modulus and opposite phase to the phase jump to be compensated.

8. A method according to claim 7, wherein the phase jump to be compensated being periodic and predictable by the function L/LDFT, said complex is expressed in the form:
decp=exp(2*j*pi*numc/LDFT*L*(NUMT−1)),
where:
NUMT is the relative chronological number of the slices or blocks of L samples, and
numc is the IDFT channel number corresponding to the central frequency of the carrier concerned or to the ratio Fc/Fs modulo LIDFT (Fc is the required carrier frequency).

9. A method of optimizing the performance of a mobile radio system transmitter using processing operations including discrete Fourier transform (DFT) computation, filtering in the frequency domain, inverse discrete Fourier transform (IDFT) computation, and overlapping of processed sample series or blocks, said overlapping being obtained by adding LDFT-L zeros to blocks of L incident signal samples to obtain blocks of LDFT samples to be applied to a DFT of length LDFT, and wherein the LDFT samples of said blocks are rotated in such manner that the LDFT-L zeros are placed as close as possible to the center of the blocks and the L signal samples are placed on either side of the LDFT-L zeros.

10. A method according to claim 9, wherein said blocks are rotated in such a manner that the LDFT-L zeros are placed as close as possible to the center of the blocks, to within one sample if L is odd.

11. A mobile radio system transmitter including means for implementing a method according to claim 1.
